(19) United States
(12) Patent Application Publication
(10) Pub. No.: US 2009/0065535 A1
(43) Pub. Date: Mar. 12, 2009

(54) FLUID DISPENSER SYSTEM

(75) Inventors: Zhihua Li, Chandler, AZ (US); Harikrishnan Ramanan, Chandler, AZ (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/853,364

(22) Filed: Sep. 11, 2007

(51) Int. Cl. B67D 3/00

(52) U.S. Cl. 222/544

(57) ABSTRACT

Disclosed is fluid dispenser valve for managing a streamlined flow of fluid. The fluid dispenser valve includes a valve chamber and a fluid inlet. The valve chamber is capable of circulating the fluid. Further, the fluid inlet is configured tangentially to the valve chamber. The fluid inlet is capable of enabling the flow of the fluid into the valve chamber.

### FIELD OF THE DISCLOSURE

The present disclosure relates to a fluid dispenser system, and, more particularly to a fluid dispenser system for managing a streamlined flow of fluid.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 is a cross-sectional view of a conventional fluid dispenser system;

FIG. 2 is a cross-sectional view of a portion of the conventional fluid dispenser system depicting simulation of fluid flow through the conventional fluid dispenser system;

FIG. 3 depicts a portion of a fluid dispenser system for managing a streamlined flow of fluid, according to an exemplary embodiment of the present disclosure; and

FIG. 4 depicts simulation of fluid flow through the fluid dispenser system of FIG. 3, according to an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

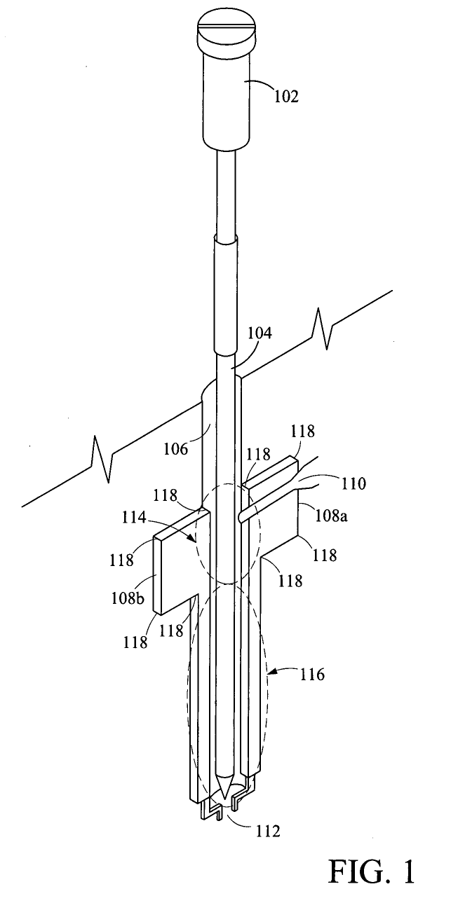

FIG. 1 is a cross-sectional view of a conventional fluid dispenser system 100 (henceforth referred to as the ‘fluid dispenser system 100’). Examples of the fluid dispenser system 100 include, but are not limited to, spray valves and degasification systems. The fluid dispenser system 100 includes a micro-adjustment 102, a micrometer needle 104, a valve body 106, a pair of elbows 108, a fluid inlet 110 and a nozzle 112. The micro-adjustment 102 and the micrometer needle 104 form a micrometer. The micrometer is a measuring instrument that measures and keeps track of quantity of fluid entering the valve body 106. The micrometer needle 104 is coupled to the micro-adjustment 102 and the micrometer needle 104 extends into the valve body 106. The micro-adjustment 102 controls the micrometer needle 104 in a manner such that rotating the micro-adjustment 102 causes a vertical displacement of the micrometer needle 104 in the valve body 106. The vertical displacement of the micrometer needle 104 and subsequently the micrometer needle 104 extending into the valve body 106 controls the amount of fluid entering the valve body 106.

The valve body 106 is coupled to the micro-adjustment 102 and disposed beneath the micro-adjustment 102. The valve body 106 is shaped as a hollow cylinder having an inner diameter. The valve body 106 is co-axial with the micrometer needle 104. The inner diameter of the valve body 106 (i.e. the hollow cylinder) is greater than an outer diameter of the micrometer needle 104. The micrometer needle 104 is received into the hollow cylinder of the valve body 106 with a space created between the inner diameter of the hollow cylinder of the valve body 106 and the outer diameter of the micrometer needle 104. Two diametrically opposite ends of the valve body 106 couple the pair of elbows 108. Each elbow 108 of the pair of elbows 108 is configured as hollow cuboid and coupled along a length of the elbow 108 at a right angle to the hollow cylinder of the valve body 106. The shape of the pair of elbows 108 is not limited to cuboids only, but may be configured in a variety of other shapes known to a person skilled in the art. A first elbow 108a of the pair of elbows 108 is coupled to the fluid inlet 110 and is configured to receive the fluid flowing from the fluid inlet 110. The fluid inlet 110 is connected at an angle to the first elbow 108a to facilitate the fluid to flow into the first elbow 108a such that velocity and direction of the fluid flow may be controlled. It will be apparent to a person skilled in the art that velocity of the fluid will depend on various properties possessed by the fluid such as viscosity, density, and the like. The fluid enters from the fluid inlet 110 into the first elbow 108a and then circulates in hollow cylinder of the valve body 106. The fluid flows in the space created around the micrometer needle 104 in the valve body 106. The valve body 106 is coupled to the nozzle 112 at an end portion of the valve body 106 opposite to an end portion coupling the micro-adjustment 102. The nozzle 112 is configured to dispense the fluid that is collected in the valve body 106. It will be apparent to a person skilled in the art that basic components required for operating the fluid dispenser system 100 have been described above. However, the fluid dispenser system 100 may include other additional components.

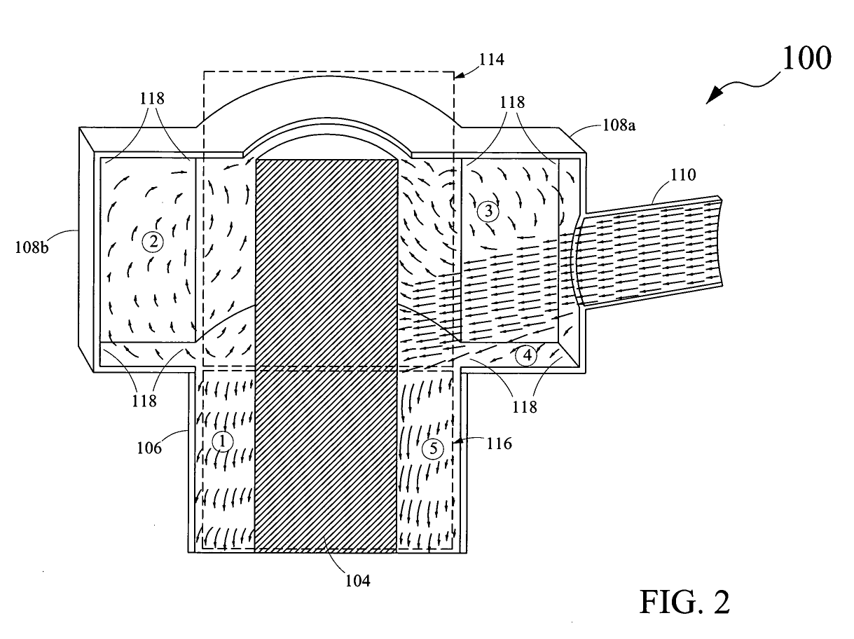

FIG. 2 is a cross-sectional view of a portion of the conventional fluid dispenser system 100 of FIG. 1 depicting simulation of fluid flow through the conventional fluid dispenser system 100. The fluid dispenser system 100 includes the micrometer needle 104, the valve body 106, the pair of elbows 108 and the fluid inlet 110. The valve body 106 includes an upper portion 114 and a lower portion 116. The upper portion 114 and the lower portion 116 of the valve body 106 form hollow cylinders that are coaxial and have a common inner diameter. The upper portion 114 of the valve body 106 couples the pair of elbows 108 at two diametrically opposite ends of the valve body 106. The pair of elbows 108 is configured as hollow cuboids and the elbows 108 are coupled along their respective lengths at right angles to the upper portion 114 of the valve body 106. The first elbow 108a of the pair of elbows 108 is coupled to the fluid inlet 110 and is configured to receive the fluid flow from the fluid inlet 110. The fluid inlet 110 is connected at an angle to the first elbow 108a to facilitate the fluid to flow into the first elbow 108a such that velocity and direction of the fluid flow may be controlled. It will be apparent to a person skilled in the art that velocity of the fluid will depend on various properties possessed by the fluid such as viscosity, density, and the like. The fluid enters from the fluid inlet 110 into the first elbow 108a and then circulates in the upper portion 114 and the lower portion 116 of the valve body 106. For the purpose of description, the hollow cylinders formed by the upper portion 210 and the lower portion 212 of the valve body 106 will be referred to in singular form as a ‘hollow cylinder’. The inner diameter of the hollow cylinder of the valve body 106 is greater than an outer diameter of the micrometer needle 104. The micrometer needle 104 is received into the hollow cylinder of the valve body 106 with a space created between the inner diameter of the hollow cylinder of the valve body 106 and the outer diameter of the micrometer needle 208. The fluid flows in the space created around the micrometer needle 104 in the valve body 106.

For the purpose of representing simulation, direction of the fluid flow is represented by a plurality of arrows, as shown in FIG. 2. A dense collection of the plurality of arrows may represent greater velocity of the fluid flow as compared to a scant collection of the plurality of arrows. The fluid having a particular velocity enters through the fluid inlet 110 as shown in the simulation diagram. Due to coupling of the fluid inlet 110 with the first elbow 108a, the plurality of arrows is directed from the first elbow 108a towards the hollow cylinder of the valve body 106 with a strong directional flow. The plurality of arrows is separated into numerous regions due to physical characteristics possessed by the fluid such as unsteady shear layers present in a cross-section of the fluid flow. The pair of elbows 108 has sharp corner portions 118 leading to instability of shear layers of the fluid. The plurality of arrows gets distributed into various regions, such as 1, 2, 3, 4 and 5, as shown in FIG. 2. The region 1 of the fluid flow exists on an opposite side of the first elbow 108a within the hollow cylinder of the valve body 106 and is horizontally lower than the first elbow 108a, due to a force of gravity acting on the fluid. A part of the fluid coming from the fluid inlet 110 impinges on the region 1. Under the effect of kinetic energy of fluid particles and gravitational force acting on the fluid, a strong directional flow with a high velocity may be created at the region 1, as represented by a dense collection of the plurality of arrows. The region 2 exists within a second elbow 108b of the pair of elbows 108 and diametrically opposite to the first elbow 108a. Another part of the fluid coming from the fluid inlet 110 with a high velocity may get directed into the second elbow 108b due to a sharp corner portion 118 at the coupling of the second elbow 108b and the hollow cylinder, forming the region 2. The fluid is re-circulated in the region 2 and a part of the fluid from the region 2 flows back to the first elbow 108a, as depicted in FIG. 2. Yet another part of the fluid coming from the fluid inlet 110 may get directed to the region 3 existing in an upper corner of the first elbow 108a. As shown by the plurality of arrows in region 3, the fluid re-circulates in the region 3 and may recombine with the fluid coming from the fluid inlet 110. Still another part of the fluid coming from the fluid inlet 110 may get directed towards the region 4 as depicted by the plurality of arrows in the region 4. The fluid re-circulates in the region 4 and may recombine with the fluid coming from the fluid inlet 110. Further, another part of the fluid coming from the fluid inlet 110 gets directed towards the region 5 under force of gravity. The fluid entering the region 5 impinges on a lower sharp corner portion 118 near the coupling of the first elbow 108a with the hollow cylinder of the valve body 106, thereby decreasing the velocity of the fluid entering the region 5. The region 5 exists within the hollow cylinder of the valve body 106, specifically in the lower portion 116 and on a same side as the first elbow 108a, as shown in FIG. 2.

The region 2, the region 3 and the region 4 are potential stagnation zones that cause accumulation of the fluid. The fluid accumulates due to non-uniform flow pattern of the fluid at the sharp corner portions 118, leading to separation and recirculation of the fluid. The accumulation of the fluid in the stagnation zones results in inconsistent weight of fresh fluid that is dispensed when change of fluid material takes place. The fluid accumulated in the stagnation zones may get circulated with the fresh fluid that may have a different density or viscosity, thus leading to inconsistent weight of the fresh fluid being dispensed. Further, the accumulation of the fluid in the stagnation zones also leads to increase in time required to clean the valve, thereby impacting process operation time and associated cost during development and production.

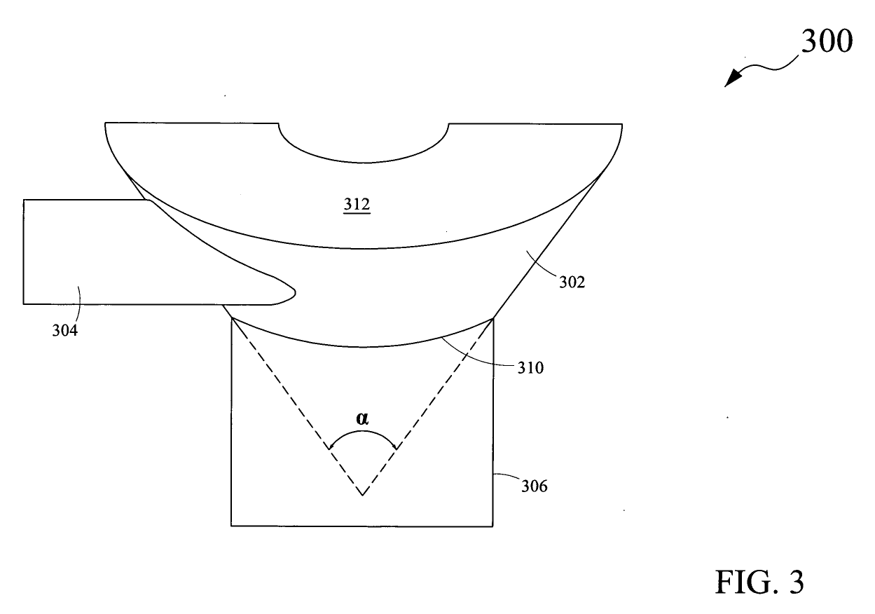

FIG. 3 depicts a portion of a fluid dispenser system 300 for managing a streamlined flow of fluid, according to an exemplary embodiment of the present disclosure. In an embodiment, the fluid dispenser system 300 may be a fluid dispenser valve. Examples of the fluid dispenser system 300 include, but are not limited to, spray valves, and degasification systems.

The fluid dispenser system 300 includes a valve chamber 302, a fluid inlet 304, a cylindrical fluid chamber 306 and a micrometer needle (not shown in FIG. 3). The valve chamber 302 is capable of circulating the fluid. The valve chamber 302 may be a cone-shaped valve chamber with an open frustum end 310 and a closed base end 312, as shown in FIG. 3. Henceforth, for the purpose of description, the valve chamber 302 will be the cone-shaped valve chamber 302. However, it will be apparent to a person skilled in the art that the valve chamber 302 may be of any other suitable shape that has rounded corners. The valve chamber 302 may be placed as shown in FIG. 3 with the closed base end 312 narrowing down towards the open frustum end 310 of the valve chamber 302 forming a hollow space therebetween. The closed base end 312 of the valve chamber 302 includes a circular central opening 314. In one embodiment, a vertex angle (α) of the valve chamber 302 may range from about 60 degrees to about 120 degrees. The valve chamber 302 is hollow and the fluid flows from the fluid inlet 304 into the valve chamber 302. The fluid inlet 304 is configured to couple tangentially to the valve chamber 302 resulting in a rounded-angled structure of the fluid inlet 304. The fluid inlet 304 is capable of enabling the flow of the fluid into the valve chamber 302. The fluid inlet 304 may be shaped as a cylindrical pipe, as shown in FIG. 3. However, it will be apparent to a person skilled in the art that the fluid inlet 304 may be of any other suitable shape. Further, there may be a pump (not shown in the figure) connected at an end portion of the fluid inlet 304, to pump the fluid into the valve chamber 302 at a controlled velocity. The fluid inlet 304 coupled tangentially with the valve chamber 302 creates a uniform and streamlined flow of the fluid within the fluid dispenser system 300. Furthermore, recirculation of the fluid and formation of low velocity region (stagnation zones) in the valve chamber 302 is reduced with the tangential coupling. The flow of the fluid is directed along a lateral surface of the valve chamber 302 (not shown) and a lateral surface of the cylindrical fluid chamber 306 (not shown).

The cylindrical fluid chamber 306 is coupled to the valve chamber 302 at the open frustum end 310. Further, the cylindrical fluid chamber 306 is co-axial with the valve chamber 302. A diameter of the cylindrical fluid chamber 306 is equal to a diameter of the open frustum end 310 (henceforth also referred to as a ‘diameter of the cylindrical fluid chamber 306’) of the open frustum end 310 of the valve chamber 302. The valve chamber 302 and the cylindrical fluid chamber 306 together form a combined conical and cylindrical hollow space. The cylindrical fluid chamber 306 has the micrometer needle disposed within a hollow space formed by the cylindrical fluid chamber 306. A portion of the micrometer needle extends into the valve chamber 302 and passes through the circular central opening 314 present on the closed base end 312 of the valve chamber 302. The circular central opening 314 accommodates the micrometer needle that is disposed in the cylindrical fluid chamber 306. The micrometer needle is co-axial with the cylindrical fluid chamber 306. An outer diameter of the micrometer needle is less than the diameter of the open frustum end 310 of the valve chamber 302 and the diameter of the cylindrical fluid chamber 306, thereby creating space for the fluid to flow therebetween. The fluid flow takes place in the space created between the outer diameter of the micrometer needle and the diameter of the cylindrical fluid chamber 306 and within the valve chamber 302. The fluid entering through the fluid inlet 304 flows through the valve chamber 302 and the cylindrical fluid chamber 306 around the micrometer needle and out from a nozzle (not shown).

The nozzle is configured at an end portion of the cylindrical fluid chamber 306 and away from the valve chamber 302. The nozzle is capable of dispensing the fluid. The fluid dispensed may be used in chip attach process, etching process, and the like. In the present disclosure, for the purpose description, only essential components relevant to illustrate the flow of fluid in the fluid dispenser system 300 have been described. However, it will be apparent to a person skilled in the art that the fluid dispenser system 300 may include additional components as well. Further, the fluid dispenser system 300 may be suitable to dispense other forms of matter with similar properties as fluids, such as gaseous matter. For example, the fluid dispenser system 300 may be suitable to dispense gases such as air and nitrogen for the purpose of cleaning the fluid dispenser system 300.

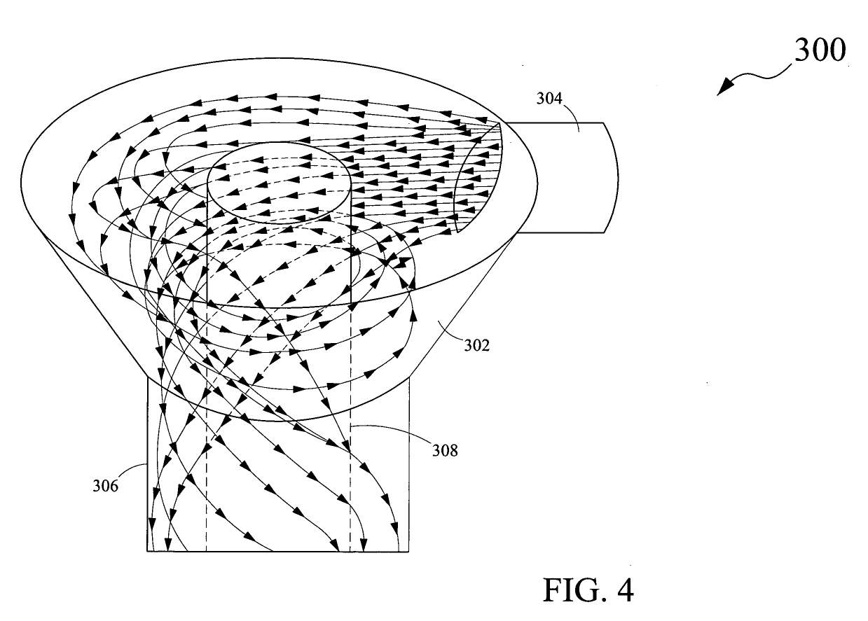

FIG. 4 depicts simulation of the fluid flow through the fluid dispenser system 300 of FIG. 3, according to an exemplary embodiment of the present disclosure. For the purpose of description of FIG. 4, reference will be made to components described in the FIG. 3 above. The fluid dispenser system 300 includes the valve chamber 302, the fluid inlet 304, the cylindrical fluid chamber 306 and a micrometer needle 308. FIG. 4 is shown to include the valve chamber 302 coupled co-axially to the cylindrical fluid chamber 306. The micrometer needle 308 is disposed co-axially within the cylindrical fluid chamber 306 and extends into the valve chamber 302. The fluid flows from the fluid inlet 304 into the hollow space created between the micrometer needle 308 and conical and cylindrical surfaces of the valve chamber 302 and the cylindrical fluid chamber 306 respectively. The fluid being dispensed may be at least one of an application fluid and a cleaning fluid. The cleaning fluid may be at least one of water and isopropanol.

For the purpose of representing the simulation diagram, direction of the fluid flow is depicted by a plurality of arrows, as shown in FIG. 4. A dense collection of the plurality of arrows represents a greater velocity of the fluid flow as compared to a scant collection of the plurality of arrows. The plurality of arrows is directed tangentially from the fluid inlet 304 and circulated within the valve chamber 302, as shown in FIG. 4. The valve chamber 302 has a conical surface area that provides uniform and streamlined flow of the fluid. The direction of the plurality of arrows appears to form a vortex flow of the fluid. The tangential coupling of the fluid inlet 304 into the valve chamber 302 prevents direct impingement of the fluid flow on the micrometer needle 308 thereby reducing the fluid flow separation.

In one embodiment, the simulation shown in FIG. 4 is performed for water flow. Pressure of the water at the fluid inlet 304 is assumed to be at 45 PSI (pound-force per square inch). The simulation shows a steady state water flow during cleaning of the application fluid present in the fluid dispenser system 300. In the simulation shown, the plurality of arrows flow in a vortex in the valve chamber 302. The fluid is acted upon by kinetic energy along with a centripetal force that keeps the fluid directed along the conical surface of the valve chamber 302. Thereafter, the fluid begins to lose velocity and flows into the cylindrical fluid chamber 306 under a force of gravity. The fluid coming from the fluid inlet 304 flows in the space created between an outer diameter of the micrometer needle 308 and the diameter of the cylindrical fluid chamber 306 and the valve chamber 302. A part of the fluid from the vortex flows through a cylindrical surface of the cylindrical fluid chamber 306 from behind the micrometer needle 308, as shown by the arrows in the simulation. Yet another part of the fluid from the vortex flows through a cylindrical surface of the cylindrical fluid chamber 306 from a front side of the micrometer needle 308, as shown by arrows in the simulation. Cumulatively, the fluid flows in a uniform manner without forming stagnation zones where the fluid could collect.

In accordance with an embodiment of the present disclosure, a fluid dispenser system, such as the fluid dispenser system 300 including a valve chamber, such as the valve chamber 302, a fluid inlet, such as the fluid inlet 304, a cylindrical fluid chamber, such as the cylindrical fluid chamber 306 and a micrometer needle, such as the micrometer needle 308, is provided. The valve chamber is cone-shaped and is coupled tangentially to the fluid inlet. The valve chamber is co-axially coupled to the cylindrical fluid chamber in a manner such that a diameter of a frustum of the valve chamber coincides with a diameter of the cylindrical fluid chamber. This arrangement creates a combination of a conical and cylindrical hollow space for fluid flow within the fluid dispenser system. The conical and cylindrical hollow space is also configured to receive the micrometer needle having a diameter less than the diameter of the frustum of the valve chamber. The fluid flows in the space created between the diameter of the micrometer needle and the diameter of the frustum of the valve chamber. The tangential fluid inlet prevents direct impingement of the fluid on the micrometer needle, thereby reducing the fluid flow separation. The cone-shape of the valve chamber provides a corner-free surface for the fluid to flow. This eliminates fluid stagnation zones that were formed due to non-uniform flow patterns at sharp corners. Further, the cone-shape of the valve chamber leads to streamlined fluid flow that causes improved valve cleaning and maintenance, thereby reducing cost.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A fluid dispenser valve for managing flow of fluid, the fluid dispenser valve comprising:
a valve chamber capable of circulating the fluid; and
a fluid inlet configured tangentially to the valve chamber, the fluid inlet capable of enabling the flow of the fluid into the valve chamber.

2. The fluid dispenser valve of claim 1, wherein the valve chamber is a cone-shaped valve chamber.

3. The fluid dispenser valve of claim 2, wherein a vertex angle of the cone-shaped valve chamber is in a range from about 60 degrees to about 120 degrees.

4. The fluid dispenser valve of claim 1, wherein the fluid inlet configured tangentially to the valve chamber facilitates a streamlined flow of the fluid in the valve chamber of the fluid dispenser valve.

5. The fluid dispenser valve of claim 1, wherein the fluid is at least one of an application fluid and a cleaning fluid.

6. The fluid dispenser valve of claim 5, wherein the cleaning fluid is at least one of water and isopropanol.

7. The fluid dispenser valve of claim 1 further comprising a cylindrical fluid chamber coupled to the valve chamber, the cylindrical fluid chamber configured to receive the fluid from the valve chamber.

8. The fluid dispenser valve of claim 7, wherein the cylindrical fluid chamber is coaxial with the valve chamber.

9. The fluid dispenser valve of claim 8 further comprising a micrometer needle disposed in the cylindrical fluid chamber and coaxial with the cylindrical fluid chamber, wherein a portion of the micrometer needle extends into the valve chamber.

10. A fluid dispenser system for managing flow of fluid, the fluid dispenser system comprising:
a valve chamber capable of circulating the fluid;
a fluid inlet connected tangentially to the valve chamber and configured to supply the fluid into the valve chamber;
a cylindrical fluid chamber coupled to the valve chamber and configured to receive the fluid from the valve chamber; and
a micrometer needle disposed in the cylindrical fluid chamber and extending into the valve chamber.

11. The fluid dispenser system of claim 10, wherein the valve chamber is a cone-shaped valve chamber.

12. The fluid dispenser system of claim 11, wherein a vertex angle of the cone-shaped valve chamber is in a range from about 60 degrees to about 120 degrees.

13. The fluid dispenser system of claim 10, wherein the cylindrical fluid chamber is coaxial with the valve chamber.

14. The fluid dispenser system of claim 10, wherein the micrometer needle is coaxial with the cylindrical fluid chamber.
